(19) United States
(12) Patent Application Publication
(10) Pub. No.: US 2026/0362011 A1
(43) Pub. Date: Nov. 12, 2026

(54) CONTROL APPARATUS, CONTROL METHOD, AND STORAGE MEDIUM STORING PROGRAM

(71) Applicant: CANON KABUSHIKI KAISHA, Tokyo (JP)

(72) Inventor: HIDEAKI HOSHINO, Kanagawa (JP)

(21) Appl. No.: 19/664,773

(22) Filed: Apr. 30, 2026

(30) Foreign Application Priority Data
May 8, 2025 (JP) 2025-078026

(51) Int. Cl. H04N 23/695; G06T 7/11; H04N 23/60

(52) U.S. Cl. CPC H04N 23/695; G06T 7/11; H04N 23/64; G06T 2207/20104; G06T 2207/30196

(57) ABSTRACT

A control apparatus acquires position information on a plurality of subjects, adjusts at least one of an imaging direction and an angle of view of an imaging apparatus based on the position information so that the plurality of subjects is within an imaging range of the imaging apparatus, and clips, form a captured image, a partial image corresponding to a subject that is at least one subject among the plurality of subjects and is selected by a user, the captured image having been captured by the imaging apparatus that had at least one of the imaging direction and the angle of view adjusted so that the plurality of subjects is within the imaging range.

### BACKGROUND

### Field of the Technology

The present disclosure relates to a control technique for controlling an imaging apparatus.

### Description of the Related Art

Imaging systems make use of imaging apparatuses to, for example, automatically track and capture an image of a subject as an imaging target in a space where a plurality of subjects are present. In this system, if the subject as the imaging target is switched to another subject, pan-tilt-zoom (hereinbelow, referred to as PTZ) of the imaging apparatus is controlled to capture an image of the other subject.

Japanese Patent Laid-Open No. 2021-87059 describes a control technique suitable for switching a subject as an imaging target to another subject. An imaging apparatus described in Japanese Patent Laid-Open No. 2021-87059 outputs an image with a first angle of view corresponding to a subject before switching, and controls an imaging range so that the first angle of view and a second angle of view corresponding to another subject fit therein. Then, after the second angle of view fits in the imaging range, the imaging apparatus clips an image with the second angle of view from the captured image and outputs the image.

According to the technique described in Japanese Patent Laid-Open No. 2021-87059, the imaging range is set in advance. As such, it may not be possible to handle a case where another subject present outside the imaging range is set as the imaging target. In this case, there is a risk of image disturbance or an important scene being missed.

### SUMMARY

According to an aspect of the present disclosure, a control apparatus acquires position information of a plurality of subjects, adjusts at least one of an imaging direction and an angle of view of an imaging apparatus based on the position information so that the plurality of subjects is within an imaging range of the imaging apparatus, and clips, from a captured image, a partial image corresponding to a subject that is at least one subject among the plurality of subjects and is selected by a user, the captured image having been captured by the imaging apparatus that had at least one of the imaging direction and the angle of view adjusted so that the plurality of subjects is within the imaging range.

Features of the present disclosure will become apparent from the following description of embodiments with reference to the attached drawings. The following description of embodiments is described by way of example.

### BRIEF DESCRIPTION OF THE DRAWINGS

FIG. 1 illustrates an example of an overall configuration according to an embodiment.

FIG. 2 illustrates an example of a configuration of an imaging apparatus.

FIG. 3 is a flowchart illustrating a flow of control processing according to a first embodiment.

FIG. 4 illustrates an example of an operation of a control apparatus according to the first embodiment.

FIG. 5 illustrates an angle of view and a clipped image according to the first embodiment.

FIG. 6 is a flowchart illustrating a flow of control processing according to a second embodiment.

FIG. 7 illustrates an example of a graphical user interface (GUI) screen for setting a subject composition.

FIG. 8 illustrates an angle of view and a clipped image according to the second embodiment.

FIG. 9 is a flowchart illustrating a flow of control processing according to a third embodiment.

FIG. 10 illustrates an example of an operation of a control apparatus according to the third embodiment.

### DESCRIPTION OF THE EMBODIMENTS

Embodiments of the present disclosure will be described below with reference to the attached drawings. The embodiments which will be described below do not restrict the present disclosure. All of combinations of features described in the embodiments are not always essential to the means for solution according to the present disclosure. Configurations of the embodiments may be modified or changed as appropriate depending on a specification and various conditions (usage conditions, usage environment, and the like) of an apparatus to which the present disclosure is applied. In the following embodiments, duplicated descriptions of the same or similar configurations and processing steps will be omitted.

### First Embodiment

According to the present embodiment, a system is described below as an example, that automatically tracks and captures images of a plurality of subjects in a space where the plurality of subjects is present so that they are within an imaging range of an imaging apparatus. According to the present embodiment, in order to distinguish a case of tracking only a specific subject, tracking a plurality of subjects so that they are within the imaging range is referred to as multiple subject tracking. According to the present embodiment, pan-tilt-zoom (PTZ) control is performed to perform multiple subject tracking so that a plurality of subjects is all within the imaging range of the imaging apparatus, and an image of a specific subject is clipped from among the plurality of subjects.

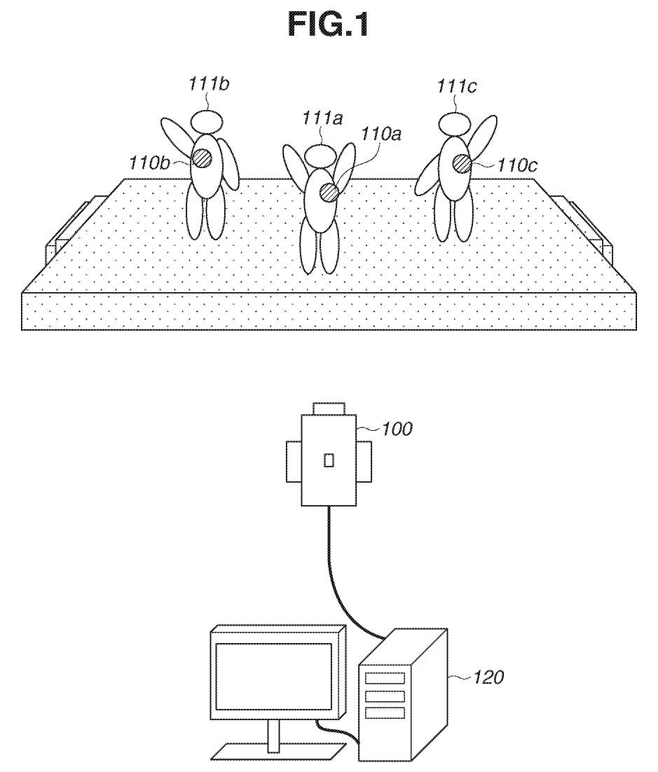

FIG. 1 illustrates an example of a schematic overall configuration that includes an imaging apparatus 100 according to the present embodiment, an external apparatus 120 connected to the imaging apparatus 100, and a plurality of persons who are subjects as imaging targets of the imaging apparatus 100. In the example in FIG. 1, the imaging apparatus 100 captures images of persons on a stage as subjects 111a to 111c, in chronological order for each frame. Further, according to the present embodiment, each of the persons as the subjects 111a to 111c holds (wears or the like) a wireless remote unit. In the example in FIG. 1, the subject 111a holds a wireless remote unit 110a, the subject 111b holds a wireless remote unit 110b, and the subject 111c holds a wireless remote unit 110c. In the following description, in a case where the subjects 111a to 111c are described without being specified, they are described as "subjects 111". Similarly, in a case where the wireless remote units 110a to 110c are not specified, they are described as "wireless remote units 110".

The configuration illustrated in FIG. 1 is merely an example, and the present disclosure is not limited to this configuration. In the case of FIG. 1, the three wireless remote units 110a to 110c are held by each of the three persons who are the subjects, but the number of wireless remote units is not limited to three, and one subject person may hold two or more wireless remote units. In other words, the number of subject persons does not have to match the number of wireless remote units. According to the present embodiment, it is assumed that the external apparatus 120 is a personal computer with a monitor, but is not limited to this, and may be, for example, a tablet terminal, a server, or the like. The number of external apparatuses 120 connected to the imaging apparatus 100 is not limited to one and may be multiple. Further, the external apparatus 120 is not essential and may be omitted, and the imaging apparatus 100 may have a function of the external apparatus 120.

The imaging apparatus 100 includes an imaging unit that changes an imaging direction and an angle of view, namely an imaging target area (an imaging target range) by a pan-tilt-zoom (PTZ) operation. The imaging apparatus 100 also performs wireless communication with the wireless remote units 110 and calculates a direction and a distance to each of the wireless remote units 110. For wireless communication between the imaging apparatus 100 and the wireless remote units 110, wireless communication techniques such as Bluetooth® and ultra-wideband (UWB) can be used.

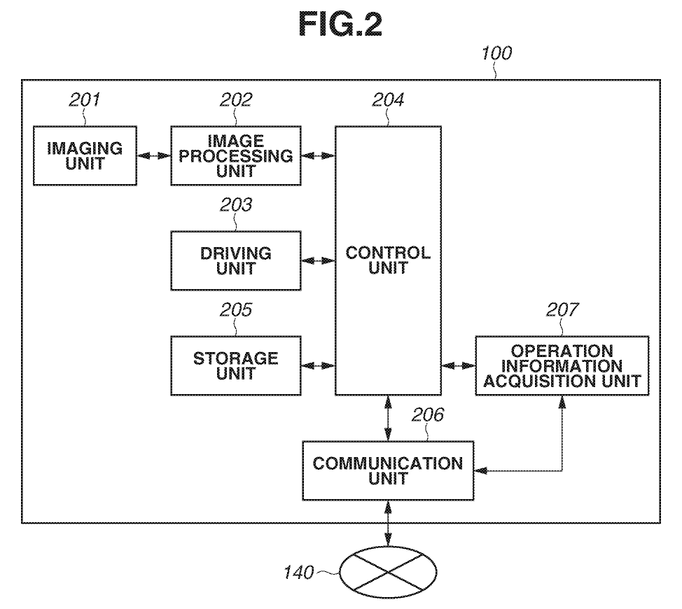

FIG. 2 illustrates an example of a configuration of the imaging apparatus 100.

The imaging apparatus 100 includes an imaging unit 201, an image processing unit 202, a driving unit 203, a control unit 204, a storage unit 205, a communication unit 206, an operation information acquisition unit 207, and the like. The imaging apparatus 100 receives operation information input by a user to the external apparatus 120 and performs PTZ control based on the operation information to change the imaging direction and the angle of view. The imaging apparatus 100 may also have a preset function of setting, for example, the imaging direction and the angle of view to an imaging direction and an angle of view that are registered in advance. Further, the imaging apparatus 100 transmits a captured image and various information to the external apparatus 120 in response to a request from the external apparatus 120.

The imaging unit 201 includes an imaging optical system that includes a focus lens, a zoom lens, and the like, an imaging element, a mechanical driving system that drives these components, a circuit, and the like. According to the present embodiment, the imaging unit 201 also includes a pan-tilt head function (for example, an electric pan-tilt head) of changing the imaging direction of the imaging apparatus 100 by pan-tilt driving. The imaging element is configured with an image sensor such as a charge coupled device (CCD), a complementary metal oxide semiconductor (CMOS), or the like and its peripheral circuit, and outputs to the image processing unit 202 an imaging signal obtained by photoelectrically converting light that forms an image on a light receiving surface by the imaging optical system.

The image processing unit 202 performs image processing such as noise removal and gamma correction on the imaging signal input from the imaging unit 201 to generate an image signal (hereinbelow, referred to as a captured image, or simply as an image). In the case of the present embodiment, the image processing unit 202 also has a digital PTZ function of clipping a partial image from a part of a captured image. Then, the image processing unit 202 transmits the clipped image to the control unit 204 using the digital PTZ function. According to the present embodiment, a partial image clipped using the digital PTZ function is referred to as a clipped image below.

The image processing unit 202 is also performs processing based on a control command received from the control unit 204. For example, in a case where a control command instructing image quality adjustment is received from the control unit 204, the image processing unit 202 changes an image processing parameter and adjusts the image quality. Further, the image processing unit 202 outputs setting contents such as an exposure setting and time information to the control unit 204.

The driving unit 203 performs a PTZ operation to change a pan-tilt direction or a zoom magnification of the imaging unit 201 of the imaging apparatus 100. In other words, the driving unit 203 includes a mechanical driving system and a driving source motor that drive the pan-tilt head included in the imaging unit 201 in the pan-tilt direction, a mechanical driving system and a driving source motor that change the zoom magnification (namely a focal length) of the zoom lens of the imaging unit 201, and the like. The driving unit 203 operates a driving system that moves the imaging direction of the imaging unit 201 of the imaging apparatus 100 in the pan-tilt direction based on a pan-tilt (PT) driving control command transmitted from the control unit 204. The driving unit 203 also operates a driving system that moves the zoom lens of the imaging unit 201 based on a zoom driving control command transmitted from the control unit 204.

The driving unit 203 also includes a sensor (encoder) for identifying an orientation of the imaging apparatus 100, namely, a PTZ position of the imaging unit 201. According to the present embodiment, the PTZ position is a pan-tilt position (hereinbelow, referred to as the PT position) corresponding to the imaging direction of the imaging unit 201 and a zoom lens position (hereinbelow, referred to as the Z position) indicating a focal length of the zoom lens. According to the present embodiment, the sensor (encoder) for identifying the orientation of the imaging apparatus 100 (the PTZ position of the imaging unit 201) is, for example, a photointerrupter (PI). According to the present embodiment, a photointerrupter (PI) is described as an example, but it is not limited to this, and another sensor may be used as long as it can identify the orientation of the imaging apparatus 100.

Then, the driving unit 203 acquires the PTZ position (the PT position and the Z position) of the imaging unit 201 by calculating the PT position based on a PT driving amount and a PI detection value and identifying the Z position from a driving amount of the zoom lens. The driving unit 203 transmits the acquired PTZ position value to the control unit 204, and the control unit 204 outputs the PTZ position value to the storage unit 205 to store it. According to the present embodiment, an example is described in which the driving unit 203 acquires the PTZ position value, but the driving unit 203 may acquire an arbitrary conversion value that identifies the PTZ position.

According to the present embodiment, an example is described in which the imaging unit 201 of the imaging apparatus 100 has a PT function. However, it may also be configured such that PT driving of the imaging apparatus 100 is performed by an external pan-tilt head (not illustrated) separate from the imaging apparatus 100, in other words, an imaging function and a PT driving function may be configured separately. In this case, the driving unit 203 outputs a PT driving control command from the control unit 204 to the external pan-tilt head (not illustrated), and the control unit 204 causes the storage unit 205 to store the PT driving control command output by the driving unit 203 to the external pan-tilt head.

The control unit 204 functions as a control apparatus that controls the entire imaging apparatus 100. The control unit 204 is a central processing unit (CPU) and can be realized by, for example, the CPU executing a control program. The control unit 204 may also be configured in a combination with an application specific integrated circuit (ASIC) or the like. Further, the control unit 204 performs analysis processing on various control commands acquired via the communication unit 206, a radio signal from the wireless remote unit 110, an image captured by the imaging unit 201, and the like. Then, the control unit 204 controls the imaging apparatus 100 based on the analysis results. The control apparatus according to the present embodiment also includes an image clipping function of the above-described image processing unit 202 in addition to the functions of the control unit 204.

For example, in a case where a control command related to PTZ driving control transmitted from the external apparatus 120 is acquired via the communication unit 206, the control unit 204 outputs the PTZ driving control command with respect to the driving unit 203 based on the control command. The control unit 204 also stores, in the storage unit 205, information about the PTZ position acquired from the driving unit 203, various types of acquired data, information about the lens of the imaging unit 201, a preset registration content registered by a user, which is described below, and the like. Further, although details will be described below, the control unit 204 controls the image processing unit 202 to identify a clipping position of a partial image in an image captured by the imaging unit 201 and to generate the partial image at the clipping position from the captured image as a clipped image.

The storage unit 205 functions as a work area of the control unit 204 and a temporary storage area for data and a function of storing various programs, various types of setting information, an image captured by the imaging unit 201, and the like. For example, the function as the work area and the temporary storage area for data is realized by a random access memory (RAM), and the function of storing various programs, various types of setting information, an image captured by the imaging unit 201, and the like is realized by a flash memory storage or the like. The storage unit 205 stores, for example, information about the PTZ position from the driving unit 203, the control command and preset registration content from the control unit 204, data about the captured image or the clipped image subjected to image processing by the image processing unit 202, and the like. These information and data are stored in the storage unit 205 together with system information in the imaging apparatus 100.

The communication unit 206 receives various control commands from the external apparatus 120 via a network 140, appropriately distinguishes the received various control commands, and transmits them to the control unit 204 or the operation information acquisition unit 207. The communication unit 206 also acquires PTZ position information, preset information, the captured image and its thumbnail image, the clipped image, a setting content of the imaging apparatus 100, and the like from the storage unit 205, and transmits them to the external apparatus 120. Further, the communication unit 206 performs wireless communication with the wireless remote unit 110 and transmits information acquired from the wireless remote unit 110 to the control unit 204 and the storage unit 205.

According to the present embodiment, it is assumed that the control unit 204 acquires various control commands from the external apparatus 120 via the network 140, but it may acquire a control command from another external apparatus. For example, the control unit 204 may acquire a control command related to the image quality or white balance from an external apparatus different from the external apparatus 120 via the network 140. Further, the control unit 204 may not have to receive various control commands.

The operation information acquisition unit 207 receives, from the communication unit 206, the control command related to the operation of the imaging apparatus 100 among the various control commands received by the communication unit 206. According to the present embodiment, the control commands related to operations include, for example, an operation command related to PTZ driving, an operation command related to presetting, such as preset registration and update, which are described below, and the like. The control commands related to operations are generated in the external apparatus 120 by an input via a graphical user interface (GUI), which is described below, or the like. The operation information acquisition unit 207 also acquires, as control commands related to operations, control commands generated by, for example, infrared remote control, wireless remote control, wireless input from an external terminal, or an operation on a hardware switch of the imaging apparatus 100. The above-described control commands related to operations are merely examples and are not limited to these.

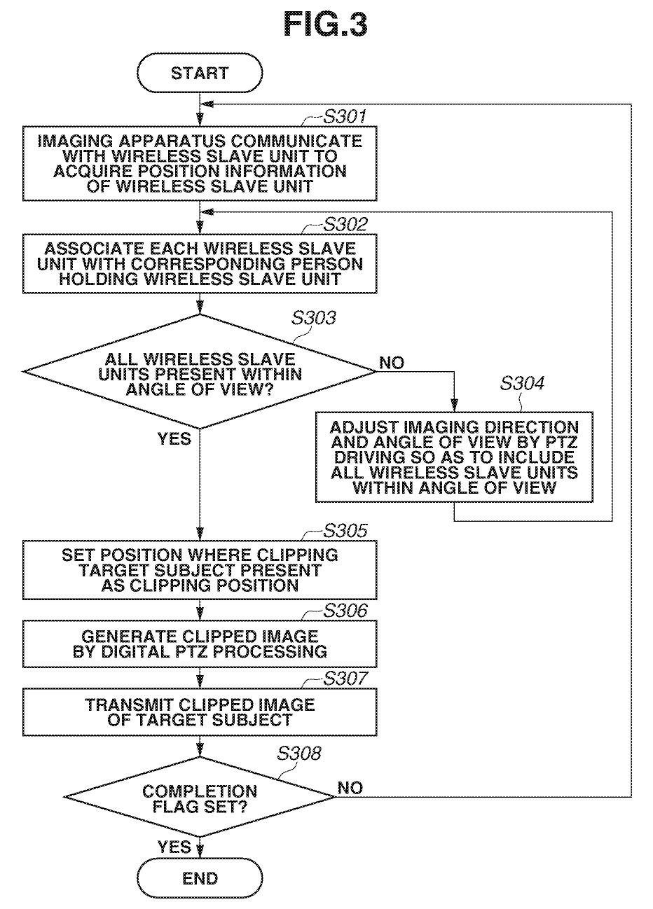

FIG. 3 is a flowchart illustrating a flow of control processing by the control unit 204 and image clipping processing by the image processing unit 202 according to the present embodiment. The control processing illustrated in the flowchart in FIG. 3 is started, for example, upon the control unit 204 having recognized that the communication unit 206 receives a radio signal from the wireless remote unit 110.

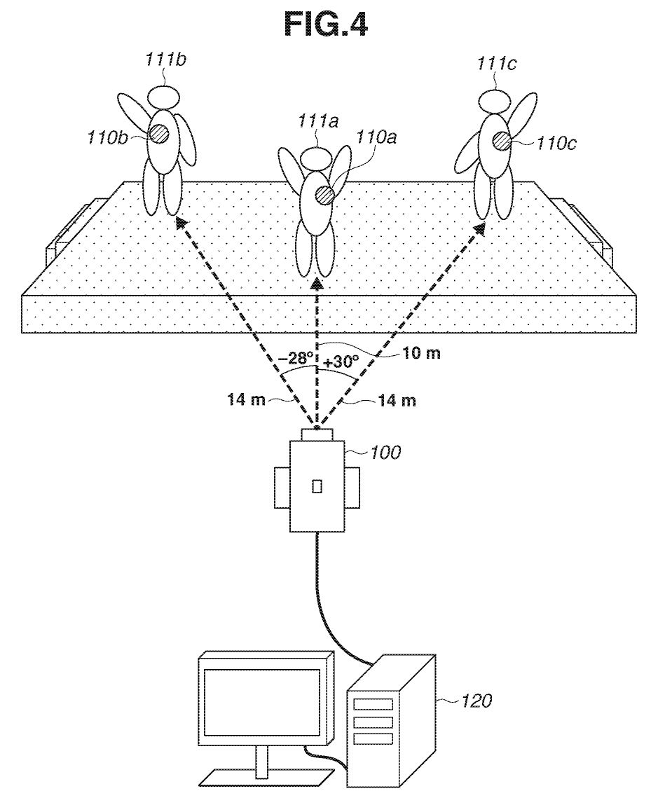

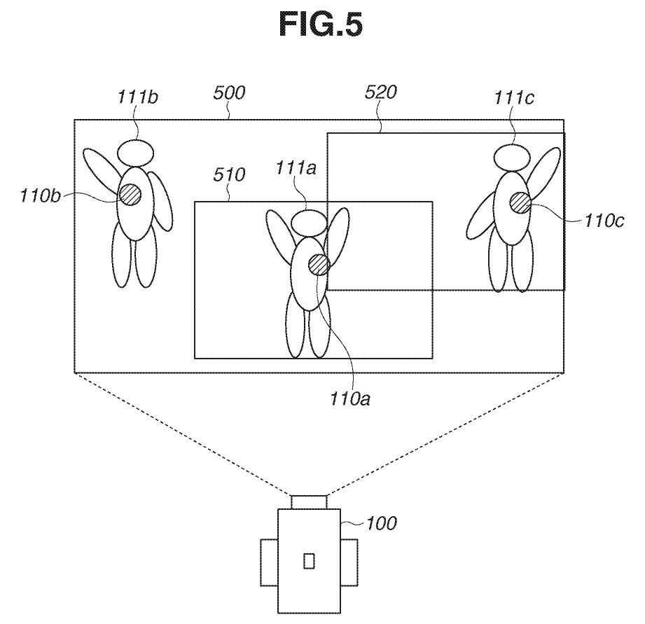

FIGS. 4 and 5 illustrate examples of operations of the imaging apparatus 100 according to the first embodiment. In the examples in FIGS. 4 and 5, as also illustrated in the example in FIG. 1, it is assumed that three persons who are the subjects 111a to 111c moving around on the stage respectively wear the wireless remote units 110a to 110c on their chests. Here, for the sake of simplicity, it is assumed that the imaging apparatus 100 and each of the wireless remote units 110 attached to the respective subjects 111 are at the same height from the ground (in other words, a tilt direction is fixed at "0 degrees" for all). Thus, only control in the pan direction is described below. It is also assumed that the imaging apparatus 100 captures images of each subject 111 on the stage for each frame in chronological order from near the front of the stage. The control processing in the flowchart illustrated in FIG. 3 is described below with reference to FIGS. 4 and 5.

First, in step S301, the control unit 204 derives position information represented by the direction and distance of each wireless remote unit 110 with respect to the imaging apparatus 100 based on a radio signal exchanged between the communication unit 206 and the wireless remote unit 110. In other words, the control unit 204 acquires the position information of the wireless remote unit 110 held by each of the plurality of subjects (persons). For example, the control unit 204 sets an optical axis direction of the imaging optical system of the imaging apparatus 100 as a reference angle (0 degrees) and acquires a relative angle value of each wireless remote unit 110 with respect to the reference angle as the direction of each wireless remote unit 110 with respect to the imaging apparatus 100. Further, the control unit 204 acquires the distance from the imaging apparatus 100 to each wireless remote unit 110 based on a time difference and a phase difference of the radio signals transmitted and received between the communication unit 206 and the wireless remote unit 110. In step S301, the control unit 204 also acquires the PTZ position information from the driving unit 203. According to the present embodiment, it is assumed that the control unit 204 performs the processing in step S301 repeatedly at predetermined time intervals and asynchronously, for example. The processing in step S301 may also be performed in synchronization with an imaging frame by the imaging apparatus 100.

In the example illustrated in FIG. 4, it is assumed that the position information of the wireless remote unit 110a is information indicating that an angle in the pan direction with respect to the reference angle of the imaging apparatus 100 is 0 degrees and the distance is 10 m. Similarly, it is assumed that the position information of the wireless remote unit 110b is information indicating that the angle in the pan direction is 28 degrees (-28°) to the left of the reference angle and the distance is 14 m. Further, it is assumed that the position information of the wireless remote unit 110c is information indicating that the angle in the pan direction is 30 degrees (+30°) to the right of the reference angle and the distance is 14 m.

Next, in step S302, the control unit 204 associates the position information of each wireless remote unit 110 with the corresponding person who is the subject 111 present within the imaging range of the imaging apparatus 100. In order to perform this association, the control unit 204 first performs person detection processing on the captured images for each frame in chronological order, thereby detecting each person who is the subject 111 present within the imaging range of the imaging apparatus 100. The person detection processing is known processing, and therefore a description thereof is omitted. Further, the control unit 204 acquires a position represented by the direction and distance with respect to the imaging apparatus 100 for each person detected by the person detection processing.

According to the present embodiment, the control unit 204 acquires the direction and distance of each person by checking how far the position of the subject person within the imaging range of the imaging apparatus 100 deviates from the center of the captured image. For example, in a case where an opening angle in the pan direction in the imaging range of the imaging apparatus 100 is 60 degrees and the subject 111 is present near an edge of the captured image, the control unit 204 determines that the direction of the subject person with respect to the imaging apparatus 100 deviates approximately 30 degrees from the center of the image. Further, the control unit 204 acquires the distance from the imaging apparatus 100 to the subject person based on a depth of field corresponding to the focal length of the imaging optical system of the imaging apparatus 100 and a focus position with respect to the subject.

Then, the control unit 204 compares the position represented by the direction and distance acquired for the subject 111 with the position represented by the direction and distance acquired for each wireless remote unit 110 in step S301, and derives the most probable combination of the subject 111 and the wireless remote unit 110.

FIG. 5 illustrates an example of a captured image 500 acquired by the imaging apparatus 100. In FIG. 5, an image 510 illustrates an example of an image within the imaging range corresponding to, for example, the position information of the wireless remote unit 110a and the person who is the subject 111a detected by person detection performed on the captured image 500. The control unit 204 compares the position information of each wireless remote unit 110 with a person detection result of each subject 111, and determines which subject 111 in the captured image 500 corresponds to which wireless remote unit 110 to derive the most probable combination of the subject and the wireless remote unit.

Next, in step S303, the control unit 204 determines whether all of the wireless remote units 110 are present within the imaging range of the imaging apparatus 100. In other words, the control unit 204 checks whether it has been able to derive all combinations of subjects 111 and wireless remote units 110 within the imaging range of the imaging apparatus 100. Then, if the control unit 204 determines that all of the wireless remote units 110 for which combinations have been derived are present within the imaging range (YES in step S303), the processing proceeds to step S305. On the other hand, if the control unit 204 determines that there is the wireless remote unit 110 not present within the imaging range (NO in step S303), the processing proceeds to step S304.

In step S304, the control unit 204 performs PTZ driving control on the driving unit 203 to adjust either or both of the imaging direction and the angle of view of the imaging apparatus 100 so that all of the wireless remote units 110 for which combinations can be derived are within the imaging range of the imaging apparatus 100. After the processing in step S304, the control unit 204 returns the processing to step S302. In this way, by capturing an image in the imaging range that is adjusted to include all the subjects 111a to 111c holding the wireless remote units 110a to 110c, the captured image 500 as illustrated in FIG. 5 can be acquired.

In step S305, the control unit 204 identifies a position of the subject to be the clipping target of the partial image by the image processing unit 202. For example, the control unit 204 identifies a position of each subject that can be the clipping target in the captured image based on the captured image transmitted from the image processing unit 202, each position information of the wireless remote unit 110, and the combinations result derived in step S302. Then, the control unit 204 identifies, from among the subjects that can be the clipping target, for example, one subject or two or more subjects instructed by a user via the external apparatus 120 as the position of the subject to be the clipping target of the partial image. In addition, the control unit 204 may identify, for example, a subject that holds a specific wireless remote unit as the clipping target subject. Further, the control unit 204 may identify a subject to be the clipping target based on face information about a person, which the image processing unit 202 acquires by image analysis processing. Further, for example, the control unit 204 may identify a subject that is assumed to make specific movement or sound as the subject to be the clipping target. A method for identifying the subject to be the clipping target is not limited to these.

Next, in step S306, the control unit 204 issues a clipping command to the image processing unit 202 to instruct it to clip a partial image in a range corresponding to, for example, a size of the subject at the clipping position of the subject identified in step S305. As an example, in a case where a plurality of subjects is selected as the clipping target, the control unit 204 may set one clipping position and clipping range that includes the plurality of subjects. The control unit 204 may set the clipping position and clipping range for each of the plurality of subjects.

The image processing unit 202 that receives the clipping command from the control unit 204 generates a clipped image by clipping a partial image from the captured image using digital PTZ processing according to the clipping position and range specified by the clipping command. For example, in a case where the position of the subject 111a that holds the wireless remote unit 110a is specified as the clipping position, the image 510 as illustrated in FIG. 5 is generated as a clipped image. Then, the control unit 204 transmits the clipped image generated by the image processing unit 202 to the external apparatus 120 via the communication unit 206.

The clipped image may be transmitted to the external apparatus 120, or may be transmitted to the storage unit 205 and stored in the imaging apparatus 100, for example.

Next, in step S307, the control unit 204 transmits the clipped image generated by the image processing unit 202 to the communication unit 206, and the communication unit 206 transmits the clipped image to the external apparatus 120 via the network 140. Accordingly, the clipped image in which the specific subject is captured among the plurality of subjects is transmitted to the external apparatus 120. The control unit 204 may transmit the clipped image to, for example, the storage unit 205 for internal storage. The control unit 204 may also divide the clipped image into a plurality of streams and transmit data divided into the plurality of streams to the external apparatus 120 via the communication unit 206.

Next, in step S308, the control unit 204 checks whether a termination flag is set. For example, if the termination flag is set (YES in step S308), the control unit 204 terminates the processing in the flowchart in FIG. 3. On the other hand, if the termination flag is not set (NO in step S308), the control unit 204 returns the processing to step S301.

According to the present embodiment, the termination flag is set in a case where, for example, an instruction to terminate imaging is received from a user at any point of time.

The imaging apparatus 100 continuously clips and transmits an image as described above, for example, in chronological order for each frame, and thus can transmit the clipped images tracking the specific subject that is moving or the like, to the external apparatus 120 or the like.

Here, for example, it is assumed that the subject to be the clipping target is switched from the subject 111a holding the wireless remote unit 110a to another subject 111c holding the wireless remote unit 110c in response to an instruction from a user via the external apparatus 120. In other words, it is assumed that the subject (person) as the tracking target is switched from the subject 111a to the subject 111c. In this case, the imaging apparatus 100 performs similar clipping processing as described above on the subject 111c holding the wireless remote unit 110c as a new clipping target, thereby generating a clipped image with the subject 111c as a tracking target, such as an image 520 in FIG. 5. Then, the imaging apparatus 100 switches the clipped image to be transmitted to the external apparatus 120 from the image 510 to the image 520. Since the images 510 and 520 are images clipped from the captured image 500, the image to be transmitted to the external apparatus 120 is an image obtained by instantaneously switching the tracking target subject from the subject 111a to the subject 111c. In other words, the imaging apparatus 100 according to the present embodiment can output a tracking image without image disturbance or missing a scene even if the tracking target subject is switched from the subject 111a to the subject 111c.

As described above, the imaging apparatus 100 according to the first embodiment acquires the position information indicating the position and distance of the subject, and performs multiple subject tracking based on the position information using an optimal imaging direction and angle of view in which all the subjects are captured. Then, the imaging apparatus 100 determines the position of the specific subject from among the plurality of subjects, clips an image portion of the specific subject from the captured image, thereby transmitting the clipped image in which the specific subject is captured to the external apparatus 120 or the like. Further, according to the present embodiment, even if switching to another subject, the image can be switched to one capturing the another subject quickly and seamlessly without causing discontinuity or disturbance of the image.

According to the first embodiment, the position information indicating the position and distance of the subject is acquired using wireless communication between the wireless remote unit, but the present disclosure is not limited to this configuration. For example, the control unit 204 of the imaging apparatus 100 may generate a three-dimensional (3D) map based on an image captured by another imaging apparatus that captures an image of the entire plurality of subjects from a bird's-eye view, and derive coordinates where each subject is present based on the 3D map.

For example, an infrared sensor, a pressure sensor, or the like may be comprehensively arranged on the stage, and the control unit 204 of the imaging apparatus 100 may derive the position information of each subject based on sensor information detected by the infrared sensor or the pressure sensor.

According to the first embodiment, an example has been described in which the control unit 204 in the imaging apparatus 100 determines the clipping position of the subject, but the present disclosure is not limited to this example. For example, the external apparatus 120 may acquire the captured image and the position information of the wireless remote unit from the imaging apparatus 100, derive information indicating the clipping position and the clipping range in the same manner as described above, and transmit the information to the imaging apparatus 100.

Further, according to the present embodiment, no limitation is imposed on tracking processing for a plurality of subjects, but the present disclosure is not limited to this configuration. For example, the imaging apparatus 100 may have a function of enabling a user to set an imaging control range in advance by adjusting the imaging direction and the angle of view. Then, if the subject exceeds the imaging control range, the subject may be excluded from a target of multiple subject tracking. The imaging control range is a range in which an image can be captured by the pan-tilt-zoom (PTZ) operation. However, the user can set a limit on the pan-tilt-zoom (PTZ) operation, and according to the setting, the imaging control range may be narrower than an original imaging control range of the imaging apparatus 100.

### Second Embodiment

According to a second embodiment, an example is described in which the imaging apparatus 100 has a function of correcting how a subject appears in an image, in other words, a composition of the subject. According to the first embodiment, as an example, if the image 520 in FIG. 5 is used as a clipped image, the position of the subject in the clipped image may deviate from the center of the image depending on the position of the subject within the imaging range. In other words, if a user intends to acquire a clipped image in which the subject is located at the center of the image, the image 520 in FIG. 5 is an image in which the subject appears in a way (composition) unintended by the user. In addition, a part of the subject may be located outside the clipped image (the subject may be out of the clipped image).

Thus, according to the second embodiment, an example is described in which a clipped image can be generated that maintains a composition of a subject specified in advance, in order to prevent generation of a clipped image with a composition unintended by a user. The entire system configuration and the configuration of the imaging apparatus 100 according to the second embodiment are the same as those illustrated in FIGS. 1 and 2 described above, so that the illustrations and descriptions thereof are omitted.

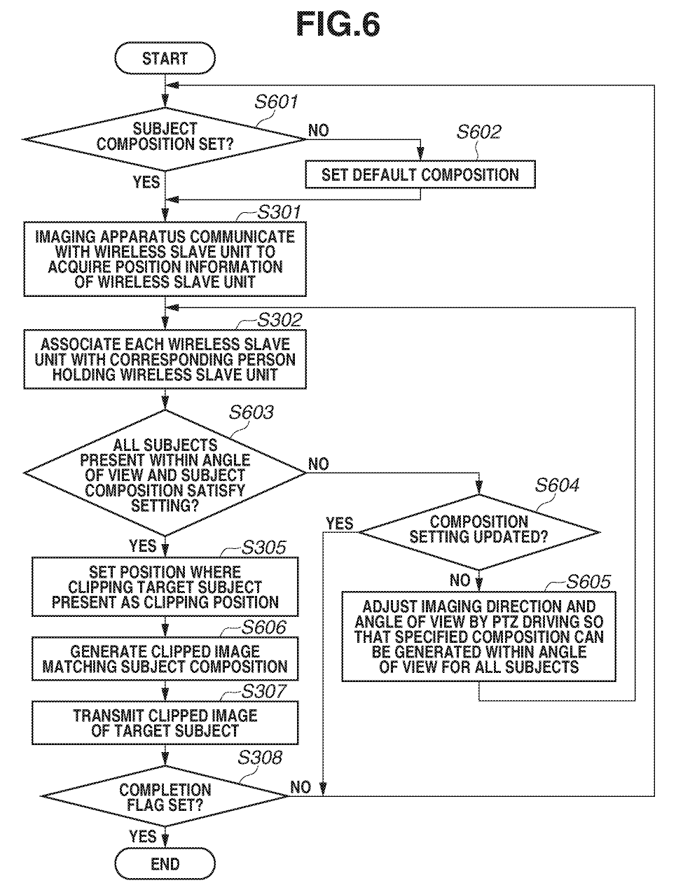

FIG. 6 is a flowchart illustrating a flow of control processing by the control unit 204 and image clipping processing by the image processing unit 202 of the imaging apparatus 100 according to the second embodiment. In the flowchart in FIG. 6, steps S301 to S308 are the same as those in the flowchart in FIG. 3, so that the descriptions thereof are omitted. The flowchart in FIG. 6 according to the second embodiment is different from the flowchart in FIG. 3 in that it includes the processing processes in steps S601 to S606 corresponding to a setting of a composition of the subject.

First, in step S601, the control unit 204 of the imaging apparatus 100 determines whether the composition of the subject is set. According to the present embodiment, a composition setting is described as including a default composition and a composition arbitrarily set by a user via the external apparatus 120, but the present disclosure is not limited to this configuration. If the control unit 204 determines that the composition is not set by the user (NO in step S601), the processing proceeds to step S602. On the other hand, if the control unit 204 determines that the composition is set by the user (YES in step S601), the processing proceeds to step S301.

In step S602, the control unit 204 calls the default composition setting.

After step S602, the control unit 204 advances the processing to step S301.

In the flowchart in FIG. 6, after step S301 and the following step S302 similar to those described above, the control unit 204 advances the processing to step S603.

A case is described below as an example in which it is determined that the composition is set by the user in step S601. In the following description, it is assumed that the composition set by the user is a composition that captures a main subject in the center of the clipping range, but the present disclosure is not limited to this configuration.

In step S603, the control unit 204 determines whether all of the subjects are present within the imaging range of the imaging apparatus 100 and the composition of the subject in a case where the clipped image is generated can satisfy the user's composition setting.

Here, for example, in the case of the captured image 500 illustrated in FIG. 5, the clipped image of the subject 111c does not capture the subject 111c at the center of the clipped image, as in the image 520. Thus, if there is even one subject among all the subjects within the imaging range that does not satisfy the user's composition setting in the clipped image (NO in step S603), the control unit 204 advances the processing to step S604. On the other hand, if it is determined that the user's composition setting can be satisfied even if an image of any subject is clipped from among all the subjects (YES in step S603), the control unit 204 advances the processing to step S305 as described above.

In step S604, the control unit 204 checks whether the composition setting is updated from the composition setting determined in step S601. The processing for checking the update of the composition setting is not limited to this, and, for example, if there is an update, the processing may be performed as interrupt processing in the middle of the processing in the present flowchart. If it is determined that the composition setting is updated (YES in step S604), the control unit 204 returns the processing to step S601. On the other hand, if it is determined that the composition setting is not updated (NO in step S604), the control unit 204 advances the processing to step S605.

In step S605, the control unit 204 performs PTZ control on the driving unit 203 to adjust the imaging direction and the angle of view so that a clipped image that satisfies the user's composition setting can be generated for all of the subjects. After step S605, the control unit 204 returns the processing to step S302.

In the flowchart in FIG. 6, after step S305, the control unit 204 advances the processing to step S606. In step S606, the control unit 204 transmits a clipping command to generate a clipped image of the subject that matches the user's composition setting to the image processing unit 202.

Accordingly, the image processing unit 202 can generate a clipped image of the subject that matches the composition setting. After step S606, the control unit 204 advances the processing to step S307.

In the flowchart in FIG. 6, in step S308, if it is determined that the termination flag is not set (NO in step S308), the control unit 204 returns the processing to step S601.

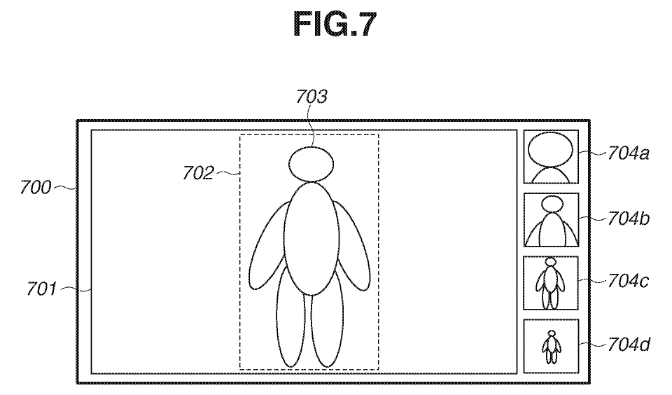

FIG. 7 illustrates an example of a graphical user interface (GUI) screen 700 that can be used by a user to set the composition of the subject in the clipped image, as in the second embodiment. According to the present embodiment, it is assumed that the GUI screen 700 is displayed on a monitor attached to the external apparatus 120, but the present disclosure is not limited to this configuration. For example, if the imaging apparatus 100 includes a built-in monitor, the GUI screen 700 may be displayed on the built-in monitor.

On the GUI screen 700, a clipped image frame 701 indicates a size of an outline of the clipped image, and a display position frame 702 indicates a display position of the subject. For example, the user can place the display position frame 702 at an arbitrary position within the clipped image frame 701 by a drag-and-drop operation using a mouse or the like provided to the external apparatus 120, and also can change the size of the frame.

Further, the user can easily select a display content of a subject 703 in the clipped image, in other words, how the subject 703 appears in the clipped image by pressing buttons 704a to 704d displayed on the GUI screen 700. In other words, the buttons 704a to 704d are virtual buttons for selecting how the subject appears in the clipped image. For example, the button 704a is a button for selecting a setting for clipping an image in which a close-up of the subject's face is captured using the imaging apparatus 100. Further, for example, the button 704b is a button for selecting a setting for clipping an image in which an upper body of the subject is captured using the imaging apparatus 100. Similarly, the button 704c is a button for selecting a setting for clipping an image in which a whole body of the subject is captured, and the button 704d is a button for selecting a setting for clipping an image in which an entire subject is captured in a wide shot.

According to the present embodiment, the buttons 704a to 704d for selecting how the subject appears in the clipped image are prepared, but the present disclosure is not limited to this configuration. The clipped image corresponding to the composition setting may be not only the clipped image in which the subject person is located roughly at the center of the image as described above, but also, for example, the clipped image, in which the subject is located at an arbitrary position in the clipped image.

Further, for example, the subject may be of any size in the clipped image.

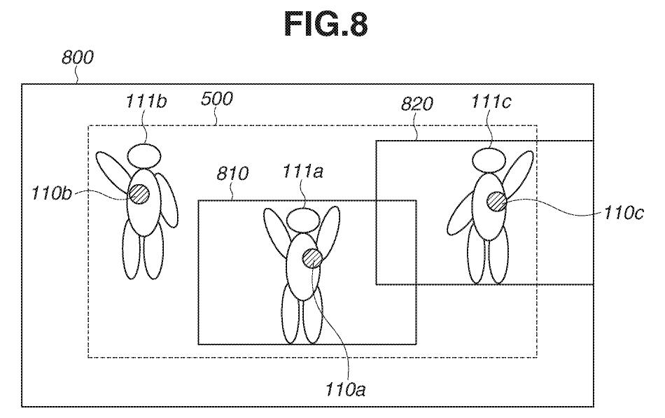

FIG. 8 is used to describe generation processing for an imaging range and a clipped image according to the second embodiment. In the example in FIG. 8, similar to the above-described example in FIG. 5, a situation is assumed in which three persons who are the subjects 111 each wears the wireless remote unit 110 on its chest. According to the second embodiment, for the sake of simplicity, it is assumed that the imaging apparatus 100 and the wireless remote units 110 attached to the subjects 111 are all at the same height from the ground (in other words, the tilt direction is fixed at "0 degrees" for all), and are also located at the same positions, as described above. Further, according to the present embodiment, it is described that the user selects a composition setting in which an entire subject is captured in a large size in the center of the image as illustrated in the GUI screen 700 in FIG. 7. Furthermore, according to the second embodiment, as in the example according to the first embodiment, a case where the clipping target is switched to the subject 111c holding the wireless remote unit 110c from a state where the subject 111a holding the wireless remote unit 110a is selected as the clipping target is described as an example.

According to the present embodiment, the control unit 204 of the imaging apparatus 100 adjusts PTZ values so that, regardless of which subject image among all the subjects present within the imaging range is clipped, a clipped image can be acquired in which the subject appears at the center of the image. In other words, for example, even in a case where an image of a subject present near the edge of the imaging range is clipped, the control unit 204 adjusts the PTZ values to set the imaging range such that an image can be captured from which a clipped image can be acquired in which the subject appears at the center.

An imaging range 800 in FIG. 8 represents an imaging range corresponding to the adjusted PTZ values, and is an imaging range that is adjusted to be wider than the imaging range corresponding to the captured image 500 in FIG. 5 indicated by a dotted line in FIG. 8.

In FIG. 8, an image 810 represents a clipped image of the subject 111a holding the wireless remote unit 110a. Further, an image 820 represents a clipped image of the subject 111c in a case where a target subject for generating a clipped image is switched from the subject 111a holding the wireless remote unit 110a to the subject 111c holding the wireless remote unit 110c. In other words, a clipped image 820 clipped from a captured image in the imaging range 800 illustrated in FIG. 8 is a clipped image in which the subject 111c holding the wireless remote unit 110c is captured at the center of the image.

As described above, according to the second embodiment, the imaging range is adjusted in accordance with the composition set by the user. According to the present embodiment, regardless of which subject image among all the subjects is clipped, it is possible to acquire a clipped image in which the subject is captured at a position according to the user's composition setting. Further, according to the present embodiment, even in a case where the subject to be the clipping target in the image is switched, a clipped image of the switched subject will be the one in which the subject appears at a position corresponding to the user's composition setting, and switching can be achieved without image discontinuity or disturbance.

According to the present embodiment, the composition setting is described using a case where one subject appears in the clipped image, but the present disclosure is not limited to this configuration. For example, composition setting is also possible in which a plurality of subjects is grouped together in one clipped image. Further, for example, in a case where another subject other than the subject to be the clipping target is present at the edge of the clipped image, an image may be clipped so as to include the another subject.

Further, according to the second embodiment, an example has been described in which the imaging range is adjusted to be able to acquire the clipped image that satisfies the composition setting, but the present disclosure is not limited to this configuration. For example, in a case where an image capturable range is determined in advance and it is difficult to acquire a clipped image that matches the composition setting in the image capturable range, it is acceptable not to clip an image based on the composition setting.

### Third Embodiment

According to a third embodiment, an example is described in which the imaging apparatus 100 has a function of preventing deterioration of image quality. According to the above-described first and second embodiments, for example, in a case where a distance between subjects is large, an image is captured by zooming out (widening the angle of view) so that all of a plurality of subject groups is included in the image. However, an image clipped from the image captured with the wide angle of view may be grainy, resulting in a low-quality image.

Thus, according to the third embodiment, if deterioration of the image quality of the clipped image is expected, at least one subject among a plurality of subjects that are targets of multiple subject tracking is excluded from target subjects to be included in an imaging direction and an angle of view for multiple subject tracking. In other words, according to the present embodiment, the imaging apparatus 100 excludes a subject that is outside a specified imaging range described below from the target of multiple subject tracking. The system configuration and the configuration of the imaging apparatus 100 according to the third embodiment are the same as those illustrated FIGS. 1 and 2 described above, so that the illustrations and descriptions thereof are omitted.

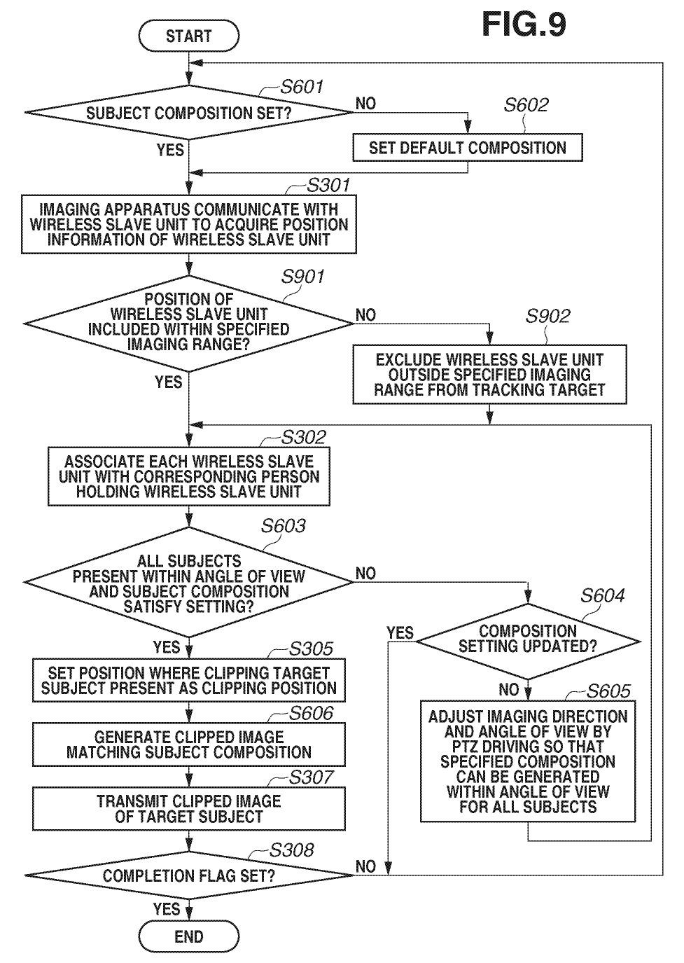

FIG. 9 is a flowchart illustrating a flow of control processing by the control unit 204 and image clipping processing by the image processing unit 202 according to the third embodiment. In the flowchart in FIG. 9, steps S301 to S308 and steps S601 to S606 are the same as those in the flowcharts in FIGS. 3 and 6, so that the descriptions thereof are omitted. The flowchart in FIG. 9 according to the third embodiment is different from the above-described flowcharts in that it includes steps S901 and S902 as processing steps related to processing for excluding the subject outside the specified imaging range from the target of multiple subject tracking.

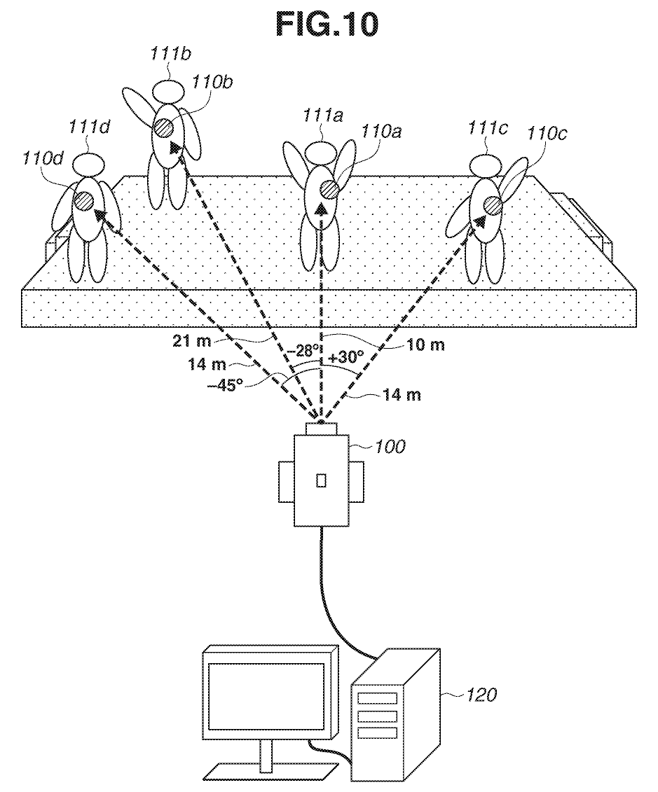

FIG. 10 illustrates an example of an operation of the imaging apparatus 100 according to the third embodiment. In the example in FIG. 10, a situation is assumed in which the wireless remote unit 110a to 110d are respectively attached to a plurality of subjects 111a to 111d (four persons in the example in FIG. 10) on a stage similar to that according to the above-described embodiments on their chests. Also in the present embodiment, it is assumed that the imaging apparatus 100 and each of the wireless remote units 110a to 110d are at the same height from the ground (the tilt direction is fixed at "0 degrees" for all), and the imaging apparatus 100 captures images from near the front of the stage.

According to the third embodiment, in step S301, the control unit 204 communicates with each of the wireless remote units 110a to 110d via the communication unit 206, and similar to the above, acquires position information represented by the direction and distance to each of the wireless remote units 110a to 110d.

In the example in FIG. 10, the position information of the wireless remote unit 110a is assumed to be information indicating that the angle in the pan direction with respect to the reference angle of the imaging apparatus 100 is 0 degrees and the distance is 10 m. The position information of the wireless remote unit 110b is assumed to be information indicating that the angle in the pan direction is 28 degrees (-28°) to the left of the reference angle and the distance is 21 m. Also, the position information of the wireless remote unit 110c is assumed to be information indicating that the angle in the pan direction is 30 degrees (+30°) to the right of the reference angle and the distance is 14 m. Further, the position information of the wireless remote unit 110d is assumed to be information indicating that the angle in the pan direction is 45 degrees (-45°) to the left of the reference angle and the distance is 14 m.

According to the third embodiment, after step S301, the control unit 204 advances the processing to step S901.

In step S901, the control unit 204 determines whether each of the wireless remote unit 110a to 110d is within the specified imaging range according to the present embodiment based on the position information of each of the wireless remote unit 110a to 110d acquired in step S301. If it is determined that each of the wireless remote unit 110a to 110d is within the specified imaging range (YES in step S901), the control unit 204 advances the processing to step S302. On the other hand, if it is determined that each of the wireless remote unit 110a to 110d is outside the specified imaging range (not within the specified imaging range, NO in step S901), the control unit 204 advances the processing to step S902.

In step S902, the control unit 204 excludes the person who is the subject 111 holding the wireless remote unit 110 that is not within the specified imaging range from the target of multiple subject tracking. After step S902, the control unit 204 advances the processing to step S302.

According to the present embodiment, it is assumed that the specified imaging range is a range in which the distance between the imaging apparatus 100 and the wireless remote unit 110 is smaller than or equal to a certain distance (for example, 15 m), or a distance between the subjects as viewed from the imaging apparatus 100, namely, an opening angle between each wireless remote unit 110 is smaller than or equal to a certain angle (60°). They are merely examples, the certain distance is not limited to 15 m, and the certain angle is not limited to 60 degrees.

In the example in FIG. 10, the distance between the wireless remote unit 110b and the imaging apparatus 100 is 21 m, which exceeds the specified imaging range of 15 m. Thus, the control unit 204 determines that the subject 111b holding the wireless remote unit 110b is outside the specified imaging range and excludes the subject 111b from the target of multiple subject tracking.

Further, in the example in FIG. 10, with respect to the reference angle of the imaging apparatus 100, the angle in the pan direction of the wireless remote unit 110d is -45 degrees, and the angle in the pan direction of the wireless remote unit 110c is +30 degrees. In other words, if viewed from the imaging apparatus 100, the wireless remote units 110d and 110c are located at positions spaced apart by 75 degrees, which exceeds the specified imaging range of 60 degrees. In this case, the control unit 204 excludes either the subject 111d holding the wireless remote unit 110d or the subject 111c holding the wireless remote unit 110c from the target of multiple subject tracking.

For example, the control unit 204 excludes the subject holding the wireless remote unit with lower imaging priority between the subject 111d and the subject 111c from the target of multiple subject tracking. The imaging priority of each wireless remote unit 110 may be set, for example, by the user via the external apparatus 120, or may be determined in advance. For example, in a case where the imaging priority of the wireless remote unit 110d is set lower than that of the wireless remote unit 110c, the control unit 204 excludes the subject 111d holding the wireless remote unit 110d from the target of multiple subject tracking.

The control unit 204 according to the present embodiment checks whether each of the wireless remote units 110a to 110d is within the specified imaging range based on the position information of the wireless remote units 110a to 110d.

Then, the control unit 204 excludes the subject 111 holding the wireless remote unit 110 outside the specified imaging range from the target of multiple subject tracking. In other words, the control unit 204 excludes the subject 111 who holds the wireless remote unit 110 that is outside the certain distance from the imaging apparatus 100 or where the distance between each of the wireless remote units 110a to 110d as viewed from the imaging apparatus 100 is greater than a certain angle, among each of the wireless remote units 110a to 110d, from the target of multiple subject tracking.

If there are three or more wireless remote units 110 that exceed the specified imaging range of 60 degrees, the control unit 204 excludes the subjects 111 from the target of multiple subject tracking in ascending order of imaging priority of the respective wireless remote units. The imaging priority of the wireless remote unit may be changed according to the distance from the imaging apparatus 100, or the imaging priority of the wireless remote unit 110 held by a person with a particular characteristic may be increased.

According to the present embodiment, an example has been described in which, if the distance (angle) between the wireless remote units 110 as viewed from the imaging apparatus 100 is outside the specified imaging range, the subject holding the wireless remote unit with the lower imaging priority is excluded from the target of multiple subject tracking, but the present disclosure is not limited to this configuration. For example, even in a case where the distance (angle) between the wireless remote units 110 exceeds a certain angle, the subject 111 holding the wireless remote unit 110 within the certain distance from the imaging apparatus 100 may be included in the target of multiple subject tracking.

According to the third embodiment, in step S302 and subsequent steps, the control unit 204 performs PTZ control on the driving unit 203 based on the position information of the remaining wireless remote unit 110 that is not excluded from the target of multiple subject tracking so that the subject 111 holding the remaining wireless remote unit 110 is within the imaging range. The subsequent processing is the same as described above.

As described above, according to the third embodiment, the subject that may lead to deterioration of image quality of the clipped image is excluded in advance from the target of multiple subject tracking, and the imaging range is determined based on the remaining subject as the target of multiple subject tracking. As a result, according to the third embodiment, for example, it is possible to suppress deterioration of the image quality of the clipped image due to the imaging range becoming too wide.

The embodiments described above are merely examples for implementing the present disclosure, so that the examples should not be construed as limiting the technical scope of the present disclosure. In other words, the present disclosure can be implemented in various forms without departing from its technical concept or main features.

According to the present disclosure, it is possible to prevent image disturbance or missing a scene in a case where a subject as an imaging target is switched.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-078026, filed May 8, 2025, which is hereby incorporated by reference herein in its entirety.

What is claimed is:

1. A control apparatus comprising:
one or more memories storing instructions; and
one or more processors executing the instructions to:
acquire position information on a plurality of subjects;
adjust at least one of an imaging direction and an angle of view of an imaging apparatus based on the position information so that the plurality of subjects are within an imaging range of the imaging apparatus; and
clip, from a captured image, a partial image corresponding to a subject that is at least one subject among the plurality of subjects and is selected by a user, the captured image having been captured by the imaging apparatus that had at least one of the imaging direction and the angle of view adjusted so that the plurality of subjects is within the imaging range.

2. The control apparatus according to claim 1, wherein execution of the instructions cause the one or more processors to adjust at least one of the imaging direction and the angle of view of the imaging apparatus so that, among the plurality of subjects, another subject excluding a first subject that exceeds an imaging control range of the imaging apparatus is within the imaging range.

3. The control apparatus according to claim 2, wherein the imaging control range is changed according to an instruction from a user.

4. The control apparatus according to claim 1, wherein the partial image includes two or more subjects.

5. The control apparatus according to claim 1, wherein, execution of the instructions cause the one or more processors to adjust at least one of the imaging direction and the angle of view of the imaging apparatus in a case where a position on the subject in the partial image deviates from a predetermined position so that a partial image in which the position on the subject is at the predetermined position is acquired.

6. The control apparatus according to claim 1, wherein, execution of the instructions cause the one or more processors to adjust at least one of the imaging direction and the angle of view of the imaging apparatus in a case where deterioration of image quality of the partial image is expected so that another subject excluding a second subject among the plurality of subjects is included in the imaging range.

7. The control apparatus according to claim 1, wherein execution of the instructions cause the one or more processors to adjust at least one of the imaging direction and the angle of view of the imaging apparatus so that, among the plurality of subjects, another subject excluding a third subject on which the position is outside a specified range is within the imaging range.

8. The control apparatus according to claim 7, wherein the specified range is a range that is defined by a distance between the imaging apparatus and a subject and an angle representing a distance between subjects as viewed from the imaging apparatus.

9. The control apparatus according to claim 8, wherein the distance between the imaging apparatus and the subject and the angle representing the distance between subjects as viewed from the imaging apparatus are changed in response to an instruction from a user.

10. The control apparatus according to claim 7, wherein, in a case where there is a plurality of subjects that is outside the specified range, the third subject is determined based on priority set to the subject that is outside the specified range.

11. The control apparatus according to claim 1, wherein position information of the subject is acquired based on a radio signal transmitted by wireless communication between wireless remote devices held by the subjects.

12. The control apparatus according to claim 11,
wherein a position of the wireless remote device is acquired based on the radio signal, and a combination corresponding to the subject and the wireless remote device is acquired based on a position of the subject detected from the captured image and the position of the wireless remote device, and
wherein at least one of the imaging direction and the angle of view of the imaging apparatus is adjusted so that all of the wireless remote devices in the combination corresponding to the subjects are included.

13. A method for control executed by a control apparatus, the method comprising:
acquiring position information on a plurality of subjects;
adjusting at least one of an imaging direction and an angle of view of an imaging apparatus based on the position information so that the plurality of subjects is within an imaging range of the imaging apparatus; and
clipping, from a captured image, a partial image corresponding to a subject that is at least one subject among the plurality of subjects and is selected by a user, the captured image having been captured by the imaging apparatus that had at least one of the imaging direction and the angle of view adjusted so that the plurality of subjects is included within the imaging range of the imaging apparatus.

14. A non-transitory storage medium storing a program that, when executed by one or more processors of a display control apparatus cause the display control apparatus to execute a method comprising:
acquiring position information on a plurality of subjects;
adjusting at least one of an imaging direction and an angle of view of an imaging apparatus based on the position information so that the plurality of subjects is within an imaging range of the imaging apparatus; and
clipping, from a captured image, a partial image corresponding to a subject that is at least one subject among the plurality of subjects and is selected by a user, the captured image having been captured by the imaging apparatus that had at least one of the imaging direction and the angle of view adjusted so that the plurality of subjects is included within the imaging range of the imaging apparatus.
